(19) United States
(12) Patent Application Publication
(10) Pub. No.: US 2011/0070838 A1
(43) Pub. Date: Mar. 24, 2011

(54) OPERATION OF A COGNITIVE RADIO RESOURCE COORDINATOR

(76) Inventor: Jesse Caulfield, McLean, VA (US)

(21) Appl. No.: 12/887,306

(22) Filed: Sep. 21, 2010

Related U.S. Application Data
(60) Provisional application No. 61/244,437, filed on Sep. 21, 2009.

(51) Int. Cl. H04B 17/00; H04B 15/00

(52) U.S. Cl. 455/62; 455/67.11; 455/63.1

(57) ABSTRACT

In an embodiment of the invention, a method may include receiving spectrum occupancy data regarding spectrum occupancy in a radio frequency environment, generating, with a processor, spectrum information regarding a plurality of transmission options for a transmitter based on the spectrum occupancy data, and providing the spectrum information to the transmitter.

### CROSS-REFERENCE TO RELATED APPLICATION

This application is a non-provisional application claiming priority to U.S. Provisional Application No. 61/244,437, entitled, “Improved Operation of an Unlicensed Cognitive Radio Resource Coordinator,” filed on Sep. 21, 2009, the subject matter of which is incorporated herein by reference.

### FIELD OF THE INVENTION

The present invention generally relates to communication systems and, more particularly, to methods for improving the coordination of wireless communications.

### BACKGROUND

In an effort to increase the efficiency of spectrum use and spur innovation in the development of wireless devices and services, national regulatory authorities in the United States and other countries are moving to allow unlicensed operation within otherwise unavailable, exclusively licensed frequency bands. These initiatives are colloquially referred to as allowing “White Space” operation.

Several methods to enable unlicensed operation to minimize impact on licensed operation have been disclosed. One approach allows unlicensed operation near a primary user by requiring secondary users to identify their geographic location and to avoid co-channel transmission when located within a well defined geographic protected contour. Primary users may be licensed transmitters. Secondary users may be unlicensed transmitters. U.S. Pat. No. 5,422,930 (1995) describes a solution that matches a secondary user's location to the fixed location of a telephone circuit. U.S. Pat. No. 5,511,233 (1996) accommodates secondary mobile transmitters by inferring that user's location through the analysis of interference zones and sub-bands. Finally, U.S. Pat. No. 5,974,151 (1988) incorporates GPS (global positioning system) to locate the secondary user.

A second type of spectrum sharing relies on detailed propagation modeling of the primary and secondary communication systems and channel occupancy measurements made by the secondary system (U.S. Pat. No. 5,410,737 (1995) and U.S. Pat. No. 5,752,164 (1998)). Channel measurements values are used to verify the propagation modeling estimates.

A third approach adds a beacon signal to every primary operator (U.S. Pat. No. 5,412,658 (1995)), while a fourth method assumes cooperative sharing between primary and secondary users (U.S. Pat. No. 5,428,819 (1995)) where each user makes measurements of the channel before transmitting.

A fifth method assumes that primary and secondary systems are coordinated by a central controller (U.S. Pat. Nos. 5,040,238 (1991), 5,093,927 (1992), 5,142,691 (1992), and 5,247,701 (1993)), and, when interference occurs, the central controller adjusts the secondary system's power level and/or allowed frequencies.

### SUMMARY

In accordance with one aspect, a method is disclosed which may include receiving spectrum occupancy data regarding spectrum occupancy in a radio frequency environment, generating, with a processor, spectrum information regarding a plurality of transmission options for a transmitter based on the spectrum occupancy data, and providing the spectrum information to the transmitter.

In accordance with another aspect, a computer-readable medium including software that, when executed by a processor, causes the processor to perform operations is disclosed. The operations may include receiving spectrum occupancy data regarding spectrum occupancy in a radio frequency environment, generating spectrum information regarding a plurality of transmission options for a transmitter based on the spectrum occupancy data, and providing the spectrum information to the transmitter.

In accordance with yet another aspect, a transmitter may include a receiver adapted to receive spectrum information regarding a plurality of transmission options for the transmitter. At least one processor may be coupled to the receiver and adapted to determine a transmission parameter based on the spectrum information. An output may be coupled to the at least one processor and adapted to wirelessly transmit based on the transmission parameter.

### BRIEF DESCRIPTION OF THE DRAWINGS

The accompanying drawings, which are incorporated in and constitute a part of this specification, illustrate one or more embodiments of the invention and, together with the description, explain the invention. In the drawings,

FIG. 1 illustrates a system block diagram showing a radio frequency environment where a coordinator may provide spectrum information regarding a plurality of transmission options for a transmitter based on the spectrum occupancy data in an exemplary embodiment;

FIG. 2 illustrates a time-sequence diagram showing the accommodation of temporary primary spectrum uses while also making frequencies available for secondary operation in an exemplary embodiment;

FIG. 3 illustrates a time-sequence diagram showing the interruption of secondary use to accommodate an emergency or unscheduled primary spectrum application in an exemplary embodiment;

FIG. 4 illustrates a logical block diagram showing one method of permuting an ordered channel list in an exemplary embodiment;

FIG. 5 illustrates a system block diagram showing a plurality of coordinated radio resource coordinator systems connected to each other through a communications network and collectively appearing as a single system in an exemplary embodiment;

FIG. 6 illustrates a flow chart diagramming a process in which a coordinator provides spectrum information to a transmitter in an exemplary embodiment;

FIG. 7 illustrates a block diagram of a transmitter in an exemplary embodiment; and

FIG. 8 illustrates a computer system that may be used in association with, in connection with, and/or in place of, but not limited to, any of the foregoing components and/or systems.

### DETAILED DESCRIPTION

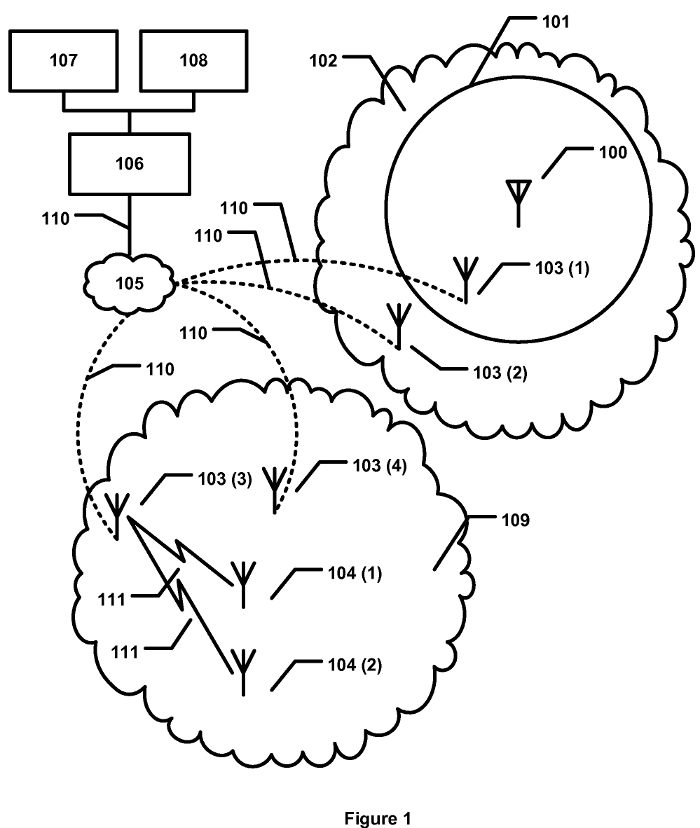

FIG. 1 illustrates a system block diagram showing a radio frequency environment where a coordinator 106 may provide spectrum information regarding a plurality of transmission options for a transmitter 103 or 104 based on the spectrum occupancy data in an exemplary embodiment.

The radio frequencies may include, such as, e.g., but not limited to, Television broadcast frequencies, mobile phone frequencies, wireless LAN frequencies, Bluetooth frequencies, GPS and two-way radio frequencies, etc.

The system may enable a plurality of independent spectrum users, e.g., transmitters and/or entities using the transmitters, to more efficiently operate on a non-interfering basis with other users through the communication of contextual spectrum occupancy and use details of other wireless services and transmissions.

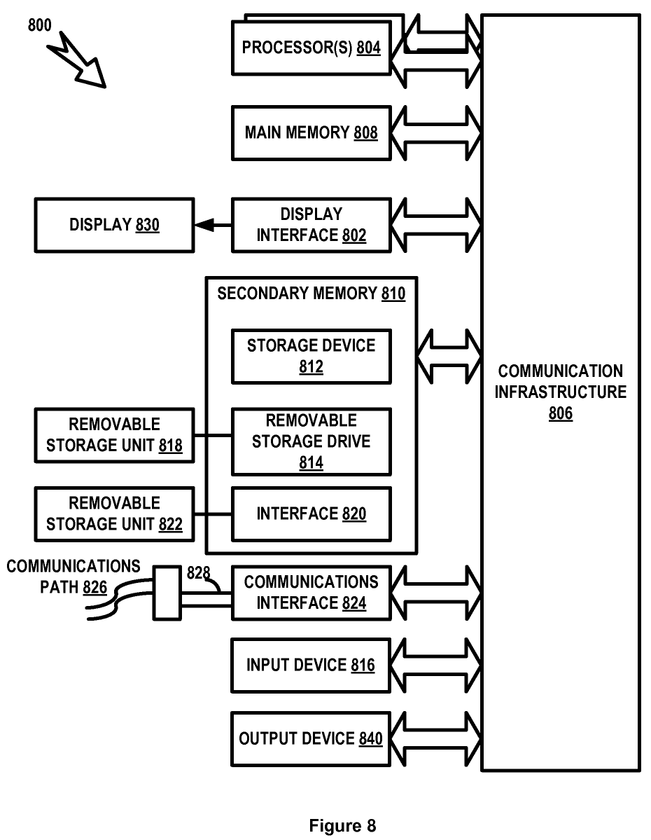

Coordinator 106 may be a computing system, as further described in regard to FIG. 8. Coordinator 106 may include, or be in communication with, a primary transmitter database 107. Primary transmitter database 107 may include transmitter information regarding primary transmitters 100. Transmitter information may include information regarding, for example, geographic location, geographic distance, operating service type, operating frequency, operating channel, or field strength of one or more primary transmitter 100. Field strength may be measured field strength and/or predicted field strength. A channel may include a frequency range which may be specified by, for example, a center frequency and/or carrier width. Primary transmitter 100 may also be known as a licensed transmitter, and may include, such as, e.g., but not limited to, a transmitter providing wireless communication services to fixed and/or mobile stations; for example, television, radio, voice and/or data services to homes, automobiles, microphone devices and/or mobile phones.

Primary transmitter 100 may also have an associated protected contour 101. Protected contour 101 may be a geography in which the signal from primary transmitter 100 may be considered protected. In an embodiment, a protected signal may not be interfered with by a secondary transmitter 103 or 104. The field strength contour 102 of a primary transmitter 100 may be the actual usable range of the primary transmitter's signal. The field strength contour 102 of the primary transmitter may extend beyond the protected contour 101. However, the primary transmitter's signal may be considered unprotected and may be interfered with outside the protected contour 101.

Secondary transmitter 103 or 104 may be known as an unlicensed transmitter, and may include, such as, e.g., but not limited to, a secondary master transmitter 103, a secondary client transmitter 104, etc. A secondary master transmitter 103 may include, such as, e.g., but not limited to, a mobile phone tower, etc. A secondary client transmitter 104 may include, such as, e.g., but not limited to, a mobile phone. Secondary transmitter 103 or 104 may avoid interfering with a protected signal by avoiding transmitting on the same frequency as a primary transmitter transmits and/or reducing the transmission strength of the secondary transmitter to reduce the range of the secondary transmission.

Coordinator 106 may also include, or be in communication with, a secondary transmitter database 108. Secondary transmitter database 108 may include transmitter information regarding secondary transmitters 103 or 104. Transmitter information may include information regarding, for example, geographic location, geographic distance, operating service type, operating frequency, operating channel, or field strength of one or more secondary transmitters 103 or 104.

Secondary transmitters 103 or 104 may also be in communication with coordinator 106 through a network 105, such as, e.g., but not limited to, the Internet via an Internet connection 110.

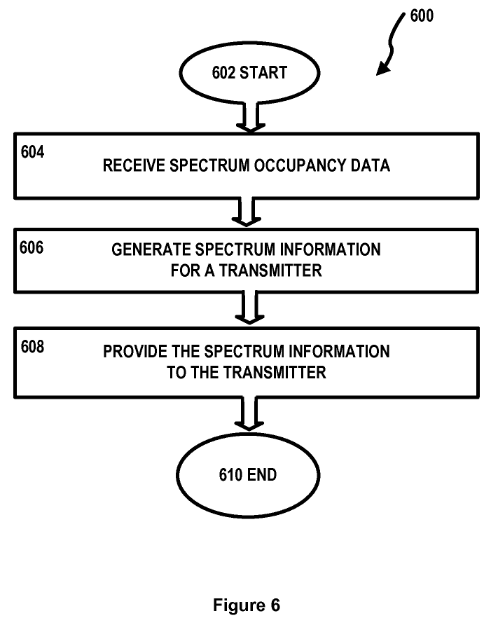

FIG. 6 illustrates a flow chart 600 diagramming a process in which coordinator 106 may provide spectrum information to a transmitter in an exemplary embodiment. Flow chart 600 may start with 602 and continue with 604. In 604, coordinator 106 may receive spectrum occupancy data regarding spectrum occupancy in a radio frequency environment. Spectrum occupancy data may include information, for example, regarding at least one of geographic location, geographic distance, operating service type, operating frequency, operating channel, or field strength, of at least one of a known transmitter or a hypothetical transmitter.

Coordinator 106 may receive spectrum occupancy data from queries for spectrum information. Queries may be received from secondary transmitters 103 or 104. Prior to transmitting, secondary transmitters 103 or 104 may identify themselves and their geographic location to coordinator 106 to query for spectrum information. Coordinator 106 may also receive spectrum occupancy data from primary transmitter database 107 and/or secondary transmitter database 108. Coordinator 106 may also receive an electronic message from a primary transmitter 100 indicating the operation of the primary transmitter 100 has terminated, thereby indicating that the channels the primary transmitter 100 are no longer in use. From 604, flowchart 600 may continue with 606.

In 606, coordinator 106 may generate spectrum information regarding a plurality of transmission options for a transmitter based on the spectrum occupancy data. Based on the spectrum occupancy data, coordinator 106 may calculate on demand or in advance each primary transmitter's protected service contour 101 and/or its field strength contour 102. Over time, coordinator 106 may construct a comprehensive operating picture which includes the location and operational details of secondary master transmitters 103 and/or secondary client devices 104. The information regarding the comprehensive operating picture may be accumulated by coordinator 106 in primary transmitter database 107 and/or secondary transmitter database 108.

Spectrum information may include a frequency or channel list, contextual information, a recommendation regarding the fitness or quality of a spectrum for radio frequency operation, an estimated interference of radio frequency operation, or information, for example, regarding at least one of geographic location, geographic distance, operating service type, operating frequency, operating channel, or field strength, of one or more transmitters in the radio frequency environment. Interference estimates and/or signal quality recommendations may be based on actual and/or hypothetical operation.

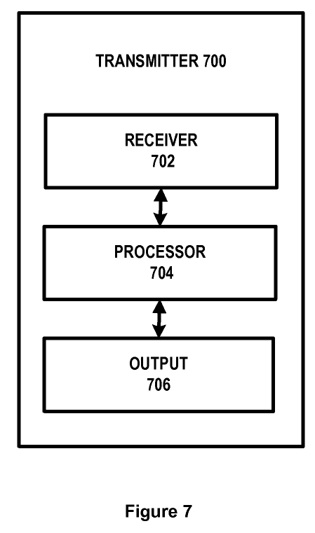

A channel list may be, for example, a list of integers corresponding to available spectrum frequency channels without additional context or detail. Where the channel list contains more than one channel, a transmitter receiving the channel list may apply internal programming logic to decide or discover the best channel on which the transmitter should operate. Other types of channel lists may also be used. Internal programming logic of the transmitter is further described below in connection with FIG. 7.

A multiplicity of secondary users located in close proximity 103(1), 103 (2), 103 (3), and 103 (4) may receive identical or similar lists of channel availability. Accordingly, coordinator 106 may assist independent secondary transmitters to avoid secondary-on-secondary interference and more optimally select operating frequencies by permuting the channel lists coordinator 106 provides to each transmitter. Permutations may incorporate algorithms that calculate, for example, potential co- and adjacent channel signal strength, interference estimates, transmitter characteristics, service requirements of other primary and secondary transmitters, etc.

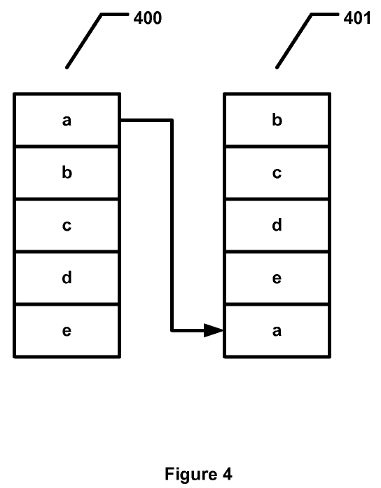

FIG. 4 illustrates the example of a “round-robin” list permutation. As shown in FIG. 4, a first channel list 400 of one transmitter including the order of “abcde” may be permuted, e.g., reordered, by moving the first element to become the last element. Using this permutation, a second channel list 401 may be generated including the order of “bcdea.” Other permutations and/or algorithms may be used in ordering a channel list, as described above.

Contextual information may include information describing the spectrum available for operation to assist intelligent channel selection by a transmitter. By cumulative effect, contextual information may also enable more efficient spectrum use and wireless co-existence for a multiplicity of unrelated and not-necessarily interoperable transmitters and services. Contextual information may be embedded within channel lists and/or communicated separately, depending upon the preference and/or configuration of each device, such as, e.g., the transmitters 103, 104. The preference and/or configuration of each device may be received from the device or received from a database.

In one example of contextual information, coordinator 106 may indicate to a secondary transmitter 103 (4) the distances to and/or the current operating channels of, other transmitters 103 (3), 104 (1) and 104 (2). The transmitters 103 (4) may thus better avoid causing unintentional interference with previously operating transmitters.

Coordinator 106 may also calculate, in advance or on demand, the field strength contours of primary 102 and secondary 109 transmitters. Field strength information may also be incorporated in a context-rich channel list or contextual information. From 606, flowchart 600 may continue with 608.

In 608, coordinator 106 may provide the spectrum information to the transmitter. The transmitter may use the spectrum information to determine how the transmitter will transmit. Using the spectrum information, the transmitter may be enabled to more efficiently select operating frequencies that are less likely to contain residual signal power from other transmitters that could prevent or otherwise degrade wireless communication. The transmitter may also be enabled to concurrently avoid interference with a primary operation by a secondary operation.

From 608, flowchart 600 may continue to 610 and end.

FIG. 7 illustrates a block diagram of a transmitter 700 in an exemplary embodiment. In an exemplary embodiment, one or more of transmitters 103 or 104 may be implemented as one or more transmitter 700. Transmitter 700 may include a receiver 702, a processor 704 coupled to receiver 702, and an output 706 coupled the processor 704.

Receiver 702 may be adapted to receive spectrum information regarding a plurality of transmission options for the transmitter. The receiver may be an electronic device that converts a radio signal from a modulated radio wave into a data signal usable by the processor 704.

At least one processor 704 may be coupled to receiver 702 and adapted to determine a transmission parameter based on spectrum information. A transmission parameter may include one or more of frequency, carrier width, transmit power, signal modulation, error correction rate, etc., according to which transmitter 700 may transmit. Transmission parameters may be determined by the at least one processor 704 based on minimizing interference with other primary and secondary operation. For example, the transmitter may select a channel that no nearby transmitters are using. In another example, the transmitter may determine transmission requirements of the transmitter and other transmitters based on the applications running on the transmitter and other transmitters. The transmitter may then select transmission parameters best suited to enable the transmitter to successfully meet the transmission requirements of the application running on the transmitter. For example, a low-speed sensor application may prefer to operate for longer periods of time within a noisy spectrum whereas a temporary high-speed data link between two or more devices may prefer the cleanest spectrum available.

Output 706 may be coupled to the at least one processor 704 and adapted to wirelessly transmit based on the transmission parameter. Output 706 may be an electronic device which propagates a radio signal according to the transmitter parameters specified by the processor 704.

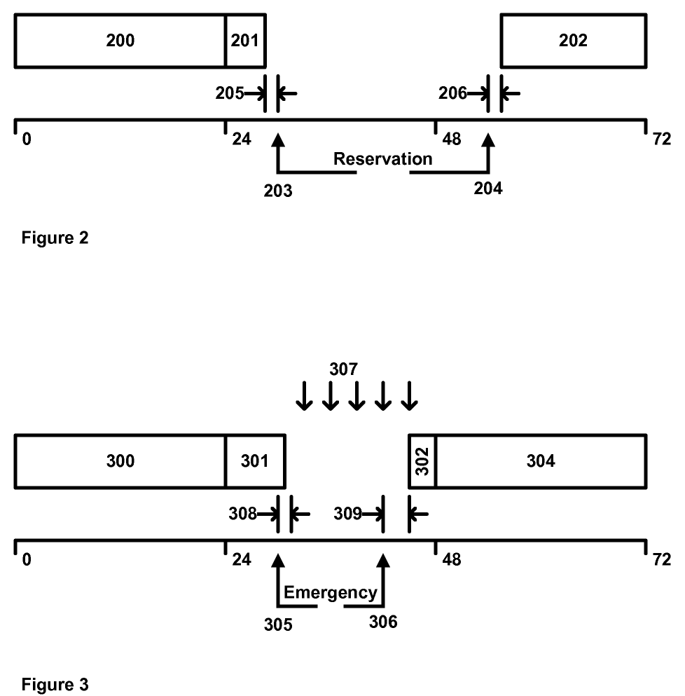

FIG. 2 illustrates a time-sequence diagram showing the accommodation of temporary primary spectrum uses while also making frequencies available for secondary operation in an exemplary embodiment. Spectrums, such as, e.g., but not limited to, channels, may be available for, or precluded from, use by secondary transmitters in fixed or prescribed increments. An example increment of 24-hours is shown by 200. These increments 200 may create a number of inefficiencies and limitations for secondary users. As an example, certain wireless microphones may be considered primary users but may only operate for short periods. Accordingly, and as example, microphone operation by a primary user on a given channel during a fixed period may render that channel unavailable for the entire period. In this example, primary spectrum use may be considered temporary if the use is less than the prescribed increment.

The time-sequence diagram shows a hypothetical 72-hour time interval broken into discrete 24-hour intervals, as example. The first interval may correspond with a time profile of a normal 24-hour unlicensed radio operation interval 200. The second interval may include a time profile of a shortened channel availability 201, a scheduled start of a temporary primary use reservation 203, and a buffer 205 between 201 and 203. The third interval may include a scheduled end of a temporary primary use reservation 204, a time profile of a “delayed-start” channel availability 202, and a buffer 206 between 204 and 202.

Short and late-start channel availability information from coordinator 106 may enable more efficient allocation of spectrum resources when protecting temporary primary users. Coordinator 106 may provide a secondary transmitter at least one of a duration or pre-determined time after which a spectrum, e.g., the channel, will become available. A “short lease” may define secondary channel availability at a normal start time but only for the specified duration, e.g., a time profile of a shortened channel availability 201. The duration may be set to instruct a secondary user that channel availability will end shortly before the primary user's reservation begins 203. Buffers 205 may ensure that unlicensed operation does not interfere with licensed operation by providing time for the unlicensed devices to vacate the spectrum before licensed operation.

Coordinator 106 may also provide a secondary transmitter at least one of a duration or pre-determined time after which a spectrum, e.g., channel, will become unavailable. A “late-start lease” may indicate that a channel is not available at the time of inquiry but is scheduled to become available at a later time within the current cycle, e.g., a time profile of a delayed-start channel availability 202. The “late-start lease” may begin following a primary user's reservation by some short buffer 206 and may either terminate at the normal time or sooner if a “short-lease” is also indicated. Both methods may be combined to enable spectrum use opportunities of varying time within any recurring interval. Combined, these techniques may greatly increase the efficiency and availability of spectrum for secondary use while providing transparent ad-hoc protection for primary users. Buffer 206 may provide time for licensed devices to vacate the spectrum before unlicensed operation.

FIG. 3 illustrates a time-sequence diagram showing the interruption of secondary use to possibly accommodate an emergency or unscheduled primary spectrum application in an exemplary embodiment. Coordinator 106 may also promote efficient spectrum sharing and enable public safety use of needed frequencies by temporarily causing the vacation of secondary users from a spectrum, e.g., channel. Under certain circumstances, coordinator 106 may enable the rapid vacation of secondary users and consequent availability of spectrum for emergency primary users to begin use at any time. When the emergency use is complete, coordinator 106 may quickly reintroduce spectrum back into inventory.

The time-sequence diagram shows a hypothetical 72-hour time interval broken into discrete 24-hour intervals, as example. The first interval may correspond with a time profile of a prescribed unlicensed radio operation interval 300 with 24 hours shown as example. The second interval may include a time profile of a shortened channel availability due to emergency interrupt action 301, the actual start of the emergency interrupt 305, a grace period 308 between the start of emergency interrupt action 305 and vacation of unlicensed operation of the channel buffer, the actual end of the emergency interrupt 306, a time profile of a delayed-start channel availability due to emergency interrupt action 302, and a gap 309 between the end of emergency interrupt 306 and restart of unlicensed operation 302. The third time interval may correspond with a second time profile of a normal unlicensed radio operation interval 304.

To vacate a channel, coordinator 106 may instruct a transmitter to temporarily cease transmission in a spectrum, e.g., the channel. Coordinator 106 may further provide the transmitter at least one of a duration or pre-determined time 307 after which the transmitter may transmit an inquiry regarding the availability of the spectrum. Specifying a delay between inquiries may allow coordinator 106 to balance the processing burden of frequent inquiries from a potentially large number of secondary devices with a desired goal of minimizing the delay 309 between an emergency's termination 306 and re-establishment of secondary operation 302. Coordinator 106 may continually provide a later status inquiry time 307 to the transmitter until the emergency reservation ends and the channel is again available for unlicensed use. Coordinator 106 may send subsequent status inquiry times 307 in response to inquiries from the transmitter.

Coordinator 106 may also receive an electronic message from a primary transmitter 100 indicating the emergency operation of the primary transmitter 100 has terminated, thereby indicating that the primary transmitter's 100 occupied spectrum is no longer in use. Accordingly, gap 309 may be the time delay between when a primary transmitter 100 indicates a channel is no longer in use and the next scheduled status inquiry from a secondary transmitter.

Coordinator 106 may be embodied on a single computer system. A single computer system embodiment may be adequate for small and mid-sized single-vendor systems where the operating environment may be modeled and mapped prior to operation. However, alternate architecture may be used to accommodate a multiplicity of independently operating, geographically distributed secondary devices. Accordingly, coordinator 106 and/or primary transmitter database 107 and/or secondary transmitter database 108 may be replicated onto a plurality of computer systems 500 which may then be geographically distributed.

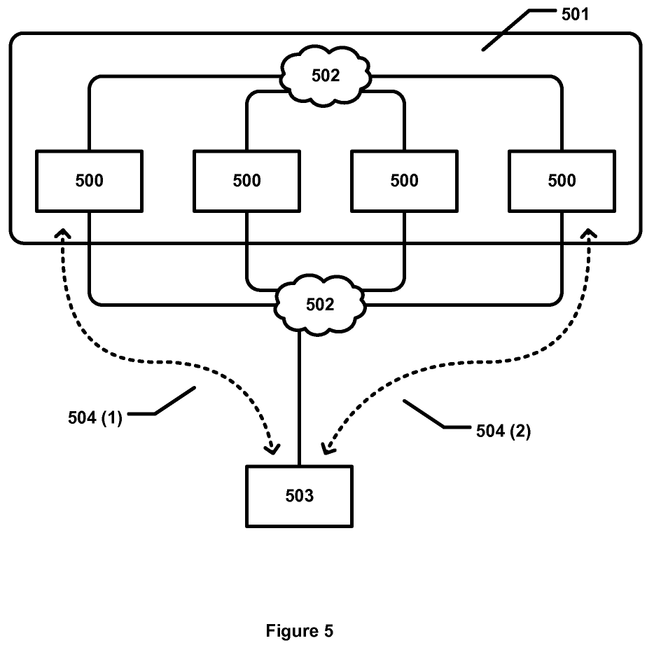

FIG. 5 illustrates a system block diagram showing a plurality of coordinated radio resource coordinator systems 500 connected to each other through a communications network 502 and collectively appearing as a single system 501 in an exemplary embodiment. Each system 500 may be configured to communicate with the others via a digital communications network 502 (e.g., the Internet) to maintain a consistent operational state. Collectively the systems 500 may constitute a distributive radio resource coordinator system 501. To the external user 503, the plurality of independent, interconnected and like-configured computers may appear as a single radio resource coordinator system, identical in function, appearance and interaction as if the external user 503 were communicating with a single computer 500. Any single communication 504 (1) may be functionally identical to other communications 504 (2) for a similar external device 503. Furthermore, the component radio resource coordinators 500 may be fungible and may be removed from service, repaired and returned to service without affecting the functionality of the aggregate system 501.

The functionality of coordinator 106 may also be provided by the inter-operation of discrete components in one or more systems 500. Components for a particular functionality may be added or removed based on the requirements of an individual system 500. For example, an additional component for calculating field contours may be added to an individual system 500 to provide additional parallel or discrete processing of field contours. Individual systems 500 of a distributive radio resource coordinator system 501 may also vary in the type of and/or number of components in the individual systems 500.

FIG. 8 depicts an exemplary embodiment of a computer system 800 that may be used in association with, in connection with, and/or in place of, e.g., but not limited to, any of the foregoing components and/or systems. The coordinator 106 may be implemented with one or more computer systems 800.

The present embodiments (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 800 is shown in FIG. 8, depicting an exemplary embodiment of a block diagram of an exemplary computer system useful for implementing the present invention. Specifically, FIG. 8 illustrates an example computer 800, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® NT/98/2000/XP/CE/7/VISTA, etc. available from MICROSOFT® Corporation of Redmond, Wash., U.S.A., SOLARIS® from SUN® Microsystems of Santa Clara, Calif., U.S.A., OS/2 from IBM® Corporation of Armonk, N.Y., U.S.A., Mac/OS from APPLE® Corporation of Cupertino, Calif., U.S.A., etc., or any of various versions of UNIX® (a trademark of the Open Group of San Francisco, Calif., USA) including, e.g., LINUX®, HPUX®, IBM AIX®, and SCO/UNIX®, etc. However, the invention may not be limited to these platforms. Instead, the invention may be implemented on any appropriate computer system running any appropriate operating system. In one exemplary embodiment, the present invention may be implemented on a computer system operating as discussed herein. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 8.

The computer system 800 may include one or more processors, such as, e.g., but not limited to, processor(s) 804. The processor(s) 804 may be connected to a communication infrastructure 806 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 800 may include a display interface 802 that may forward, e.g., but not limited to, graphics, text, and other data, etc., from the communication infrastructure 806 (or from a frame buffer, etc., not shown) for display on the display unit 830.

The computer system 800 may also include, e.g., but may not be limited to, a main memory 808, random access memory (RAM), and a secondary memory 810, etc. The secondary memory 810 may include, for example, (but may not be limited to) a hard disk drive 812 and/or a removable storage drive 814, representing a floppy diskette drive, a magnetic tape drive, an optical disk drive, a magneto-optical disk drive, a compact disk drive CD-ROM, a digital versatile disk (DVD), a write once read many (WORM) device, a flash memory device, etc. The removable storage drive 814 may, e.g., but not limited to, read from and/or write to a removable storage unit 818 in a well known manner. Removable storage unit 818, also called a program storage device or a computer program product, may represent, e.g., but not limited to, a floppy disk, a magnetic tape, an optical disk, a magneto-optical disk, a compact disk, a flash memory device, etc. which may be read from and written to by removable storage drive 814. As will be appreciated, the removable storage unit 818 may include a computer usable storage medium having stored therein computer software and/or data.

In alternative exemplary embodiments, secondary memory 810 may include other similar devices for allowing computer programs or other instructions to be loaded into computer system 800. Such devices may include, for example, a removable storage unit 822 and an interface 820. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 822 and interfaces 820, which may allow software and data to be transferred from the removable storage unit 822 to computer system 800.

Computer 800 may also include an input device 816 such as, e.g., (but not limited to) a mouse or other pointing device such as a digitizer, a keyboard or other data entry device (none of which are labeled), and/or a touchscreen integrated with display 830, etc.

Computer 800 may also include output devices 840, such as, e.g., (but not limited to) display 830, and display interface 802. Computer 800 may include input/output (I/O) devices such as, e.g., (but not limited to) communications interface 824, cable 828 and communications path 826, etc. These devices may include, e.g., but not limited to, a network interface card, and modems (neither are labeled). Communications interface 824 may allow software and data to be transferred between computer system 800 and external devices. Examples of communications interface 824 may include, e.g., but may not be limited to, a modem, a network interface (such as, e.g., an Ethernet card), a communications port, a Personal Computer Memory Card International Association (PCMCIA) slot and card, a transceiver, a global positioning system receiver, etc. Software and data transferred via communications interface 824 may be in the form of signals 828 which may be electronic, electromagnetic, optical or other signals capable of being received by communications interface 824. These signals 828 may be provided to communications interface 824 via, e.g., but not limited to, a communications path 826 (e.g., but not limited to, a channel). This channel 826 may carry signals 828, which may include, e.g., but not limited to, propagated signals, and may be implemented using, e.g., but not limited to, wire or cable, fiber optics, a telephone line, a cellular link, an radio frequency (RF) link and other communications channels, etc.

In this document, the terms “computer program medium” and “computer readable medium” may be used to generally refer to media such as, e.g., but not limited to removable storage drive 814, a hard disk installed in hard disk drive and/or other storage device 812, etc. These computer program products may provide software to computer system 800. The invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses and/or devices for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, an exemplary machine-readable storage medium may include, e.g., but not limited to, read only memory (ROM); random access memory (RAM); magnetic disk storage media; optical storage media; magneto-optical storage media; flash memory devices.

Computer programs (also called computer control logic), may include object oriented computer programs, and may be stored in main memory 808 and/or the secondary memory 810 and/or removable storage drive 814, removable storage unit 818, removable storage unit 822, also called computer program products. Such computer programs, when executed, may enable the computer system 800 to perform the features of the present invention as discussed herein. In particular, the computer programs, when executed, may enable the processor or processors 804 to provide a method to control and/or manage operation of a positioning effect detection device according to an exemplary embodiment of the present invention. Accordingly, such computer programs may represent coordinators of the computer system 800.

In another exemplary embodiment, the invention may be directed to a computer program product comprising a computer readable medium having control logic (computer software) stored therein. The control logic, when executed by the processor 804, may cause the processor 804 to perform the functions of the invention as described herein. In another exemplary embodiment where the invention may be implemented using software, the software may be stored in a computer program product and loaded into computer system 800 using, e.g., but not limited to, removable storage drive 814, hard drive 812 or communications interface 824, etc. The control logic (software), when executed by the processor 804, may cause the processor 804 to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

The exemplary embodiment of the present invention makes reference to, e.g., but not limited to, communications links, wired, and/or wireless networks. Wired networks may include any of a wide variety of well known means for coupling voice and data communications devices together. A brief discussion of various exemplary wireless network technologies that may be used to implement the embodiments of the present invention now are discussed. The examples are non-limiting. Exemplary wireless network types may include, e.g., but not limited to, code division multiple access (CDMA), spread spectrum wireless, orthogonal frequency division multiplexing (OFDM), 1G, 2G, 3G wireless, Bluetooth, Infrared Data Association (IrDA), shared wireless access protocol (SWAP), “wireless fidelity” (Wi-Fi), WIMAX, and other IEEE standard 802.11-compliant wireless local area network (LAN), 802.16-compliant wide area network (WAN), and ultrawideband (UWB) networks, etc.

IrDA is a standard method for devices to communicate using infrared light pulses, as promulgated by the Infrared Data Association from which the standard gets its name. Since IrDA devices use infrared light, they may depend on being in line of sight with each other.

The exemplary embodiments of the present invention may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless Ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11a, b, d, g, or n, such as, e.g., but not limited to, IEEE std. 802.11a, b, d, g and n (including, e.g., but not limited to IEEE 802.11g-2003, etc.), etc.

According to an exemplary embodiment, exemplary methods set forth herein may be performed by an exemplary one or more computer processor(s) adapted to process program logic, which may be embodied on an exemplary computer accessible storage medium, which when such program logic is executed on the exemplary one or more processor(s) may perform such exemplary steps as set forth in the exemplary methods.

While various embodiments have been described above, it should be understood that they have been presented by way of example only, and not limitation. Thus, the breadth and scope of the described should not be limited by any of the above-described exemplary embodiments, but should instead be defined only in accordance with the following claims and their equivalents.

1. A method comprising:
receiving spectrum occupancy data regarding spectrum occupancy in a radio frequency environment;
generating, with a processor, spectrum information regarding a plurality of transmission options for a transmitter based on the spectrum occupancy data; and
providing the spectrum information to the transmitter.

2. The method of claim 1, wherein generating spectrum information comprises determining spectrum information based on spectrum occupancy data regarding a protected zone of a primary transmitter.

3. The method of claim 2, wherein generating spectrum information comprises determining spectrum information based on avoiding interference of a protected transmission of the primary transmitter by a transmission by the transmitter.

4. The method of claim 1, wherein generating spectrum information further comprises generating spectrum information based on spectrum information for a second transmitter.

5. The method of claim 4, wherein the spectrum information comprises an ordered list of available spectrum frequencies for the transmitter, wherein generating spectrum information further comprises permutating the order of the available spectrum frequencies for the transmitter based on spectrum information for the second transmitter.

6. The method of claim 1, further comprising receiving transmitter data regarding a transmission parameter selected by the transmitter based on the spectrum information.

7. The method of claim 1, wherein spectrum information comprises at least one of:
a frequency or channel list;
contextual information;
a recommendation regarding the fitness or quality of a spectrum for radio frequency operation;
an estimated interference of radio frequency operation; or
information regarding at least one of geographic location, geographic distance, operating service type, operating frequency, operating channel, or field strength, of one or more transmitters in the radio frequency environment.

8. The method of claim 1, wherein the spectrum occupancy data comprises information regarding at least one of geographic location, geographic distance, operating service type, operating frequency, operating channel, or field strength, of at least one of a known transmitter or a hypothetical transmitter.

9. A computer-readable medium comprising software that, when executed by a processor, causes the processor to perform operations comprising:
receiving spectrum occupancy data regarding spectrum occupancy in a radio frequency environment;
generating spectrum information regarding a plurality of transmission options for a transmitter based on the spectrum occupancy data; and
providing the spectrum information to the transmitter.

10. The computer-readable medium of claim 9, the operations further comprising providing to the transmitter at least one of a duration or pre-determined time after which a spectrum will become available.

11. The computer-readable medium of claim 9, the operations further comprising providing to the transmitter at least one of a duration or pre-determined time after which a spectrum will become unavailable.

12. The computer-readable medium of claim 9, the operations further comprising instructing the transmitter to temporarily cease transmission in a spectrum.

13. The computer-readable medium of claim 12, the operations further comprising providing the transmitter at least one of a duration or pre-determined time after which the transmitter may transmit an inquiry regarding the availability of the spectrum.

14. The computer-readable medium of claim 12, the operations further comprising receiving notification from a second transmitter that a spectrum is available.

15. The computer-readable medium of claim 12, wherein the processor comprises a plurality of computer systems in communication.

16. A transmitter comprising:
a receiver adapted to receive spectrum information regarding a plurality of transmission options for the transmitter;
at least one processor coupled to the receiver and adapted to determine a transmission parameter based on the spectrum information; and
an output coupled to the at least one processor and adapted to wirelessly transmit based on the transmission parameter.

17. The transmitter of claim 16, wherein the at least one processor is adapted to determine the transmission parameter based on selecting from the plurality of transmission options.

18. The transmitter of claim 16, wherein the output is further adapted to transmit a request for the spectrum information.

19. The transmitter of claim 16, wherein the output is further adapted to transmit transmitter data regarding the transmission parameter.
